(19) United States
(12) Patent Application Publication
(10) Pub. No.: US 2026/0185188 A1
(43) Pub. Date: Jul. 2, 2026

(54) PROCESS FOR THE RECOVERY OF MANGANESE

(71) Applicant: ELEMENT 25 LIMITED, WEST PERTH, Western Australia (AU)

(72) Inventors: Neil Jonathan Graham, CHURCHLANDS, Western Australia (AU); Leon Wesley Lima, MAYLANDS, Western Australia (AU)

(73) Assignee: ELEMENT 25 LIMITED, WEST PERTH, Western Australia (AU)

(21) Appl. No.: 19/131,671

(22) PCT Filed: Nov. 23, 2023
(86) PCT No.: PCT/AU2023/051202

§ 371 Date: May 21, 2025

(30) Foreign Application Priority Data
Nov. 25, 2022 (AU) 2022903573

(51) Int. Cl. C22B 47/00; C22B 3/06; C22B 3/22; C22B 3/26

(52) U.S. Cl. CPC C22B 47/0063; C22B 3/06; C22B 3/22; C22B 3/26; C22B 47/009

(57) ABSTRACT

The present invention relates to a method for the recovery of manganese from a manganese containing material, the method comprising the steps of: (i) subjecting the manganese containing material to an acid leach step comprising contacting the manganese containing material with an acidic leach solution to produce a leach slurry containing a pregnant leach solution and undissolved solids; (ii) subjecting the pregnant leach solution to a pressure precipitation step, comprising maintaining the pregnant leach solution at elevated temperature and pressure for a time sufficient to precipitate impurities from the pregnant leach solution; (iii) passing the product of step (ii) to a solids/liquid separation step to substantially remove the precipitated impurities and produce a purified pregnant leach solution; and (iv) recovering manganese from the purified pregnant leach solution.

### TECHNICAL FIELD

The present invention relates to a method for the recovery of manganese from manganese containing materials. More particularly, the method of the present invention utilises hydrometallurgical means to extract manganese and a pressure precipitation process to remove impurities from the leach solution.

### BACKGROUND ART

The following discussion of the background art is intended to facilitate an understanding of the present invention only. The discussion is not an acknowledgement or admission that any of the material referred to is or was part of the common general knowledge as at the priority date of the application.

High purity manganese products such as electrolytic manganese dioxide (EMD), electrolytic manganese metal (EMM), chemical manganese dioxide (CMD) and manganese sulphate (MSM/HPMSM) are required for use in specialty metals, lithium ion battery cathodes, fertilisers, and other industrial applications. Demand for high purity manganese metal and high purity manganese sulphate is expected to increase dramatically in the foreseeable future, driven by growth in traditional end use markets but also a rapid expansion in electric vehicle production and grid storage devices capacity.

The primary source of manganese is naturally occurring ores. Manganese ores can comprise of manganese oxides, manganese carbonates, or mixtures thereof. Significant processing of such ores is required to produce the high purity products described above. Pyro- and/or hydrometallurgical processing of such materials is required to extract the manganese. The primary challenge faced is the relatively low manganese grade of many deposits and this is further complicated by the fact that manganese is often present in the Mn (IV) oxidation state which does not readily leach. Both these factors impact the economics of extraction. The leaching of manganese will also leach a number of impurities, including any K, Na, Ca, Mg, Se, Fe, Al, Cu, Pb, Ni, Si, and Co. Further processing of the leach solution is required to remove these impurities. Alkali metal salts are typically quite soluble and so are not readily precipitated from solution. This makes precipitation of such species for separation difficult, further increasing the complexity of the recovery flowsheet. Failure to remove impurities impacts the purity of the manganese product produced.

In addition to naturally occurring ores, manganese may also be recovered from other manganese containing materials including ocean nodules and recycled battery oxides/wastes. Such materials similarly require significant processing to leach the manganese values and to remove impurities before high purity manganese products can be recovered.

Throughout this specification, unless the context requires otherwise, the word “comprise”, or variations such as “comprises” or “comprising”, will be understood to imply the inclusion of a stated integer or group of integers but not the exclusion of any other integer or group of integers.

### SUMMARY OF INVENTION

In accordance with a first aspect of the present invention, there is provided a method for the recovery of manganese from a manganese containing material, the method comprising the steps of:
i. subjecting the manganese containing material to an acid leach step comprising contacting the manganese containing material with an acidic leach solution to produce a leach slurry containing a pregnant leach solution and undissolved solids;
ii. subjecting the pregnant leach solution to a pressure precipitation step, comprising maintaining the pregnant leach solution at elevated temperature and pressure for a time sufficient to precipitate impurities from the pregnant leach solution;
iii. passing the product of step (ii) to a solids/liquid separation step to substantially remove the precipitated impurities and produce a purified pregnant leach solution; and
iv. recovering manganese from the purified pregnant leach solution.

In a preferred form of the invention, the manganese containing material is an ore and/or a concentrate thereof. As would be appreciated by a person skilled in the art, ores can comprise a number of manganese containing minerals, such as oxides carbonates, micas and silicates. Ores containing manganese held in any mineral or in any valence state should be considered to fall within the scope of the present invention.

In one form of the present invention, the manganese containing material is an ocean nodule. As would be understood by a person skilled in the art, ocean nodules are mineral concretions on the sea bottom formed of concentric layers of iron and manganese hydroxides around a core.

In one form of the present invention, the manganese material is an industrial waste. Industrial wastes include material resulting from industrial processes, such as residues, or from the recycling of products, such as batteries.

In one form of the present invention, the manganese containing material undergoes one or more size reduction steps prior to the acid leach step. Preferably, the one or more size reduction steps comprise primary crushing and one or more further milling steps.

In one form of the present invention, the one or more size reduction steps reduce the particle size to below P₈₀ 10 mm. In an alternative form of the present invention, the one or more size reduction steps reduce the particle size to between P₈₀ 0.1 mm-10 mm. Preferably, the one or more size reduction steps reduce the particle size to between P₈₀ 0.1 mm-5 mm.

In one form of the present invention, the manganese containing material undergoes one or more beneficiation steps prior to the acid leach step. Preferably, the one or more beneficiation steps comprise the removal of gangue minerals and/or low manganese grade material.

Preferably, the product of the one or more size reduction steps undergoes the one or more beneficiation steps prior to undergoing the acid leach step.

In one form of the present invention, the pressure precipitation step is carried out in a pressurised reactor.

In one form of the present invention, the acid leach step and the pressure precipitation step are conducted independently. In this form of the present invention, the manganese containing material is contacted with an acidic leach solution to form a leach slurry containing a pregnant leach solution and undissolved solids and the leach slurry is subjected to the pressure precipitation step. Alternatively, the leach slurry is directed to a solid liquid separation step to remove undissolved solids and the pregnant leach solution is directed to the pressure precipitation step. Throughout this specification, unless the context requires otherwise, the word “independently” will be understood to imply that the acid leach step is conducted at a different temperature and pressure to the pressure precipitation step. This will be understood to include conducting the acid leach step in a different vessel to the precipitation step. This will also be understood to include conducting the acid leach step in the same vessel as the pressure precipitation step. Preferably, the acid leach step is substantially complete prior to conducting the pressure precipitation step. Throughout this specification, unless the context requires otherwise, the term “substantially complete” will be understood to refer to the solubilisation of at least 80% of the total possible manganese in the managanese containing material. Those skilled in the art would recognise that there is a limit to the total possible manganese that can be leached from the manganese containing material in the acid leach step. This would depend on many factors, including the particle size, pulp density, residence time, acid type and acid concentration.

In an alternative form of the present invention, the acid leach step and the pressure precipitation step are conducted concurrently. In this form of the present invention, the manganese containing material is preferably contacted with an acidic leach solution at elevated temperature and pressure to produce a leach slurry containing a pregnant leach solution and undissolved solids and the elevated temperature and pressure are maintained for a time sufficient to precipitate impurities from the pregnant leach solution. More preferably, the manganese containing material is contacted with an acidic leach solution in a pressurised reactor maintained at elevated temperature and pressure. Throughout this specification, unless the context requires otherwise, the word “concurrently” will be understood to imply that at least part of the acid leach step is conducted at the temperature and pressure of the pressure precipitation step. This should be understood to include the initial contact of the manganese containing material and the acidic leach solution at the temperature and pressure of the pressure precipitation step. This should also be understood to include the initial contact of the manganese containing material and the acidic leach solution at a temperature and pressure lower than the pressure precipitation step and the increase of the pressure and temperature prior to the acid leach step being substantially complete. It should also be understood that the pressure precipitation step may continue for a time longer than the acid leach step.

In one form of the present invention, the acid leach step comprises contacting the manganese containing material with an acidic leach solution in the presence of a reducing agent to form a leach slurry containing a pregnant leach solution and undissolved solids. Preferably, the acid leach step uses a dilute acidic leach solution.

In one form of the present invention, the reducing agent is a sugar. In one form of the present invention, the reducing agent may comprise one or more different sugars. In one form of the present invention, the sugar comprises one or more of sucrose, glucose and fructose.

In one form of the present invention, the stoichiometric ratio of reducing agent to manganese is at least 0.9:1. Preferably, the stoichiometric ratio of reducing agent to manganese is at least 1:1. In one form of the present invention, the stoichiometric ratio of reducing agent to manganese is between 1.1:1 and 1.5:1.

In one form of the present invention, the acidic leach solution comprises hydrochloric acid or sulphuric acid. Preferably, the acidic leach solution comprises sulphuric acid.

In one form of the present invention, acid concentration in the acid leach step is at least the stoichiometric amount to leach the manganese containing material. Preferably, the acid leach step is carried out with excess acid.

In one form of the present invention, the acid concentration in the acid leach step is at least 110% of the calculated stoichiometric ratio to manganese. Preferably, the acid concentration in the acid leach step is 110%-130% of the calculated stoichiometric ratio to manganese.

In one form of the present invention, the acid concentration in the acid leach step is between 1% and 40% by volume. Preferably, the acid concentration in the acid leach step is between 10% and 30% by volume.

In one form of the present invention, the leach slurry contains a free acid concentration of at least 10 g/L. In one form of the present invention, the free acid concentration is between 10 g/L and 40 g/L. Preferably, the free acid concentration is between 20 g/L and 30 g/L.

In an alternative form of the present invention, the acid leach step comprises contacting the manganese containing material with an aqueous solution of SO₂. In one embodiment, the acid leach step comprises contacting an aqueous slurry of the manganese containing material with SO₂ gas. Preferably, the SO₂ gas is sparged through a leach vessel.

In one form of the present invention, the pressure precipitation step is conducted at a pressure of at least 2 bar (absolute).

In one form of the present invention, the pressure precipitation step is conducted at a pressure between 2 and 10 bar (absolute).

In one form of the present invention, the pressure precipitation step is conducted at a temperature of at least 135° C. Preferably, the pressure precipitation step is conducted at a temperature of at least 150° C. More preferably, the pressure precipitation step is conducted at a temperature of at least 160° C.

In one form of the present invention, the pressure precipitation step is conducted at a temperature between 135° C. and 200° C. Preferably, the pressure precipitation step is conducted at a temperature between 150° C. and 180° C.

In one form of the present invention, the residence time of the pressure precipitation step is at least 30 minutes. Preferably, the residence time of the pressure precipitation step is 30-120 minutes.

In one form of the present invention, the purified pregnant leach solution is subjected to a pH conditioning step. Preferably, the pH is increased to at least 5.5.

In one form of the present invention, the purified pregnant leach solution is subjected to a sulphiding step. Preferably, the sulphiding step comprises the addition of a sulphiding agent. More preferably, the sulphiding agent is selected from NaHS, Na₂S, (NH₄)₂S, (NH₄)HS, H₂S and BaS. In one form of the present invention, the sulphiding step is conducted after the pH conditioning step.

In one form of the present invention, the purified pregnant leach solution is subjected to one or more impurity removal steps prior to the recovery of manganese. In one form of the present invention, the one or more impurity removal steps comprises an ion exchange step. In one form of the present invention, the ion exchange step is conducted after the pH conditioning step. In one form of the present invention, the ion exchange step is conducted after the pH conditioning step and the sulphiding step.

In one form of the present invention, recovering manganese from the purified pregnant leach solution comprises subjecting at least a portion of the purified pregnant leach solution to a crystallisation step to produce a manganese salt. Preferably, the crystallisation step produces MnSO₄·H₂O.

In an alternative form of the present invention, recovering manganese from the purified pregnant leach solution comprises subjecting at least a portion of the purified pregnant leach solution to an electrowinning step to produce manganese metal. Preferably, the electrowinning step produces EMM and/or EMD.

In an alternative form of the present invention, recovering manganese from the purified pregnant leach solution comprises subjecting the purified leach solution to a solvent extraction step, comprising contacting the purified leach solution with an organic solution of an extractant suitable to extract manganese ions into the organic solution and separating a loaded organic solution from an aqueous raffinate. Preferably, the solvent extraction step further comprises the recovery of manganese from the loaded organic solution.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flowsheet of a process in accordance with one embodiment of the present invention, which incorporates independent acid leach and pressure precipitation steps;

FIG. 2 is a flowsheet of a process in accordance with another embodiment of the present invention, which incorporates concurrent acid leach and pressure precipitation steps;

FIG. 3 shows a plot of the effect of temperature on the precipitation of impurities;

FIG. 4 shows a plot of the typical metal extraction and precipitation kinetics over leach (I) and pressure precipitation (pp) stages; and

FIG. 5 shows a plot of manganese recovery of successive solvent extraction contacts.

### DESCRIPTION OF EMBODIMENTS

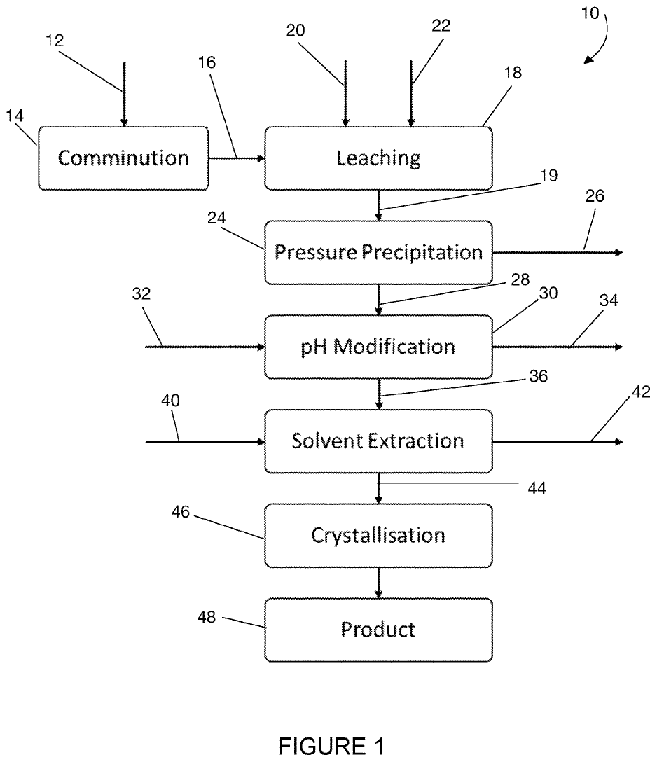

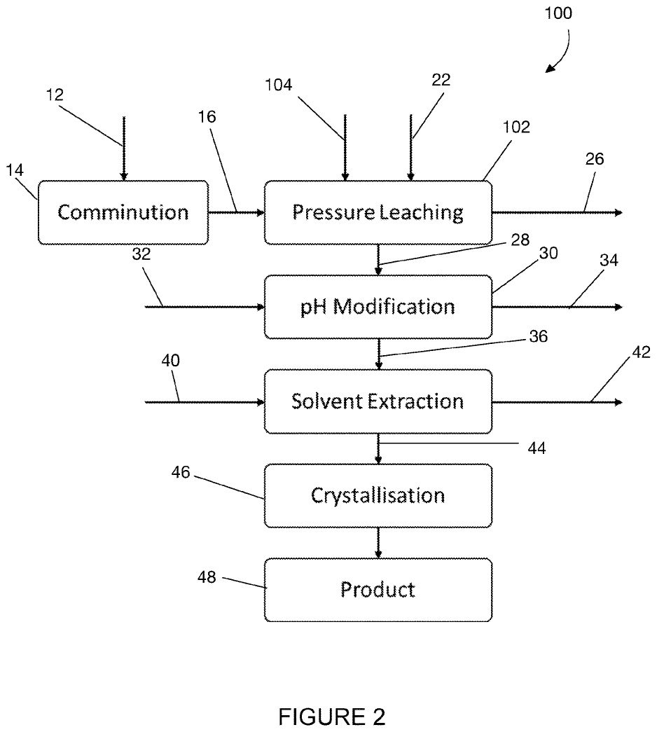

The present invention relates to a method for the recovery of manganese products from a manganese containing material. The method generally includes subjecting the manganese containing material to an acid leach step to produce a pregnant leach solution containing solubilised manganese and subjecting the pregnant leach solution to a pressure precipitation step in which the pregnant leach solution is maintained at elevated temperature and pressure for a time sufficient to precipitate impurities from the leach solution. The precipitated impurities are removed and manganese is recovered from the purified leach solution. In FIGS. 1 and 2 there are shown methods for the recovery of manganese products from a manganese containing material in accordance with two embodiments of the present invention. In the embodiment shown in FIG. 1, the acid leach step and pressure precipitation step are conducted as independent steps. In the embodiment shown in FIG. 2, the acid leach step and pressure precipitation step are conducted concurrently.

As shown in FIGS. 1 and 2, a manganese containing material 12 is subjected to one or more size reduction steps 14 to produce a processed stream 16. The one or more size reductions steps 14 may be carried out in any suitable crushing and/or milling apparatus known to those skilled in the art. The one or more size reductions steps 14 may also include a screening step (not shown) to prevent oversize material progressing to the next stage.

In one form of the present invention, the one or more size reduction steps reduce the particle size to P₈₀ 10 mm. In one form of the present invention, the one or more size reduction steps reduce the particle size to P₈₀ 9 mm. In one form of the present invention, the one or more size reduction steps reduce the particle size to P₈₀ 8 mm. In one form of the present invention, the one or more size reduction steps reduce the particle size to P₈₀ 7 mm. In one form of the present invention, the one or more size reduction steps reduce the particle size to P₈₀ 6 mm. In one form of the present invention, the one or more size reduction steps reduce the particle size to P₈₀ 5 mm. In one form of the present invention, the one or more size reduction steps reduce the particle size to P₈₀ 4 mm. In one form of the present invention, the one or more size reduction steps reduce the particle size to P₈₀ 3 mm.

In an alternative form of the present invention, the one or more size reduction steps reduce the particle size to between P₈₀ 0.1 mm-10 mm. Preferably, the one or more size reduction steps reduce the particle size to between P₈₀ 0.1 mm-5 mm.

In one form of the present invention, the manganese material 12 undergoes one or more beneficiation steps (not shown). Preferably, the one or more beneficiation steps comprises the removal of gangue minerals. Preferably, the processed stream 16 of the of the one or more size reduction steps 14 undergoes the one or more beneficiation steps.

The processed stream 16 is directed to an acid leach step where it is contacted with a leachant suitable to extract manganese into a pregnant leach solution.

In the embodiment shown in FIG. 1, the processed stream 16 is directed to an acid leach step 18 where it is contacted with a leachant suitable to extract manganese into a pregnant leach solution 19. In this embodiment, the acid leach step 18 comprises contacting the processed stream 16 with an acidic leachant solution 20 in the presence of a reducing agent 22. The use of a reducing agent will reduce the oxidation state of the metal oxides in solution to an acid soluble form, such as from Mn (4+) to Mn (2+).

In a preferred embodiment, the reducing agent is a sugar. The inventors have found that any sugar capable of reducing the manganese into an acid soluble form may be used. It is understood that the reducing agent may comprise one or more different sugars. These sugars may be used in the refined or crude form and they also may be formed in situ. It is understood that the reducing agent may comprise a non-reducing sugar which may decompose to one or more reducing sugars in acidic conditions.

In one form of the present invention, the reducing agent comprises one or more of sucrose, glucose and fructose. As would be appreciated by a person skilled in the art, the non-reducing sucrose will decompose in acidic solution to produce reducing glucose and fructose.

Without wishing to be bound by theory, it is understood that the overall leach reaction of sugar can be expressed generally as:

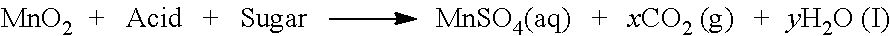

By way of example, where sulphuric acid and sucrose are used, possible reactions are as follows:

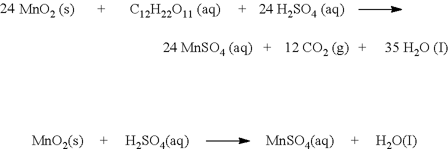

In one form of the present invention, the ratio of reducing agent to manganese is at least 0.9:1 by weight. In one form of the present invention, the ratio of reducing agent to manganese is at least 1.0:1 by weight. In one form of the present invention, the ratio of reducing agent to manganese is at least 1.1:1 by weight. In one form of the present invention, the ratio of reducing agent to manganese is at least 1.2:1 by weight. In one form of the present invention, the ratio of reducing agent to manganese is at least 1.3:1 by weight. In one form of the present invention, the ratio of reducing agent to manganese is at least 1.4:1 by weight. In one form of the present invention, the ratio of reducing agent to manganese is at least 1.5:1 by weight.

In one form of the present invention, the acidic leachant solution 20 is hydrochloric acid solution or a sulphuric acid solution. Preferably, the acidic leachant solution 20 is a sulphuric acid solution.

In one form of the present invention, acid concentration in the acid leach step is at least the stoichiometric amount to leach the manganese containing material. Preferably, the leach is carried out with excess acid.

In one form of the present invention, the acid concentration in the acid leach step is at least 110% of the calculated stoichiometric ratio to manganese. Preferably, the acid concentration in the acid leach step is 110%-130% of the calculated stoichiometric ratio to manganese.

In one form of the present invention, the acid concentration in the acid leach step is between 1% and 40% by volume. Preferably, the acid concentration in the acid leach step is between 10% and 30% by volume.

In one form of the present invention, the leach slurry contains a free acid concentration of at least 10 g/L. In one form of the present invention, the free acid concentration is between 10 g/L and 40 g/L. Preferably, the free acid concentration is between 20 g/L and 30 g/L.

In one form of the present invention, the residence time of the acid leach step is at least 15 mins. More preferably, the residence time is between 15 mins and 180 mins.

In one form of the present invention, the pulp density of the manganese containing material is controlled. Preferably, the pulp density is between 10% and 35%. More preferably, the pulp density is between 20 and 35%. The pulp density is driven by the Mn content in the manganese containing material.

In one form of the present invention, the initial temperature of the leach solution is at least 55° C. The inventors have found that as the reduction reaction is exothermic, the leach solution will self-heat once the initial temperature is achieved. This is advantageous as the heat realised in the reaction is sufficient to meet the kinetic requirements without the need for additional energy input.

The leaching step is conducted using conventional equipment, preferably including leach vessel(s) having suitable acid/temperature resistance, an agitation means and a suitable ventilation system with off-gas scrubbing.

In one form of the present invention, two or more leach vessels are used in series.

In alternative embodiment of the present invention, acid leach step 18 comprises contacting the processed stream 16 with SO₂.

Preferably, the processed feed is passed to a leach tank (not shown) where it contacted with sulfuric acid to form a leach solution. In one embodiment of the present invention a volume of SO₂ gas is pumped through the leach tank at a specified flow rate. In an alternative form of the present invention, an aqueous SO₂ solution is injected into the leach tank.

Preferably, the molar ratio of SO₂/Mn in the acid leach step is above 0.8. More preferably, the molar ratio of SO₂/Mn in the acid leach step is between 0.8 and 1.2.

In one form of the present invention, the residence time of the leaching step is controlled. Preferably, the residence time is at least 15 mins. More preferably, the residence time is between 15 mins and 120 mins.

In one form of the present invention, the SO₂ flow rate is controlled. Preferably, the flow rate is controlled such that the molar ratio of SO₂/Mn for the residence time is above 0.8. More preferably, the flow rate is controlled such that the molar ratio of SO₂/Mn for the residence time is between 0.8 and 1.2.

In one form of the present invention, the pulp density of the manganese containing material is controlled. Preferably, the pulp density is between 10% and 50%. More preferably, the pulp density is between 10 and 40%. Still preferably, the pulp density is between 20 and 40%. Still preferably, the pulp density is between 30 and 40%. Still preferably, the pulp density is approximately 40%.

In one form of the present invention, the pH of the leach is controlled throughout the acid leach step. In one form of the present invention, the pH is controlled to below 1.5. In an alternative form of the present invention, the pH is controlled to within the range of 0.8-1.2. In the context of the present invention, the term “control” will be understood to include any process by which the pH is managed throughout the acid leach step. This may include the addition of additional reagents.

In an alternative form of the present invention the pH is not controlled during the acid leach step.

The inventors have found that as the reduction reaction of higher valent Mn oxides with SO₂ is exothermic, the leach solution will self-heat as the reaction continues. This is advantageous as the heat realised in the reaction is sufficient to meet the kinetic requirements without the need for additional energy input. In one form of the present invention, the initial temperature of the leach solution is ambient temperature. Alternatively, the initial temperature of the leach solution is above ambient temperature. Alternatively, the initial temperature of the leach solution is at least 35° C. Alternatively, the initial temperature of the leach solution is at least 50° C. Alternatively, the initial temperature of the leach solution is at least 60° C. Alternatively, the initial temperature of the leach solution is at least 70° C. Alternatively, the initial temperature of the leach solution is at least 80° C.

In the embodiment shown in FIG. 1, following the completion of the acid leach step 18, the leach slurry 19 comprising the pregnant leach solution and undissolved solids is forwarded to a pressure precipitation step 24. Pressure precipitation step 24 comprises subjecting the leach slurry 19 to elevated temperature and pressure for a time sufficient to precipitate impurities from the pregnant leach solution. While the embodiment shown in FIG. 1 shows the transfer of the leach slurry 19 to the pressure precipitation step 24, it is envisaged that the leach slurry 19 may first be directed to a solid liquid separation step (not shown) to remove undissolved solids such that only the pregnant leach solution is treated in the pressure precipitation step 24.

The inventors have found that by subjecting the pregnant leach solution 19 to elevated temperature and pressure that impurities in the pregnant leach solution will precipitate. The precipitate comprises a mixture of iron solids, including haematite, jarosite, goethite and iron sulphate. The composition depends on the initial impurity levels and operating parameters, including temperature, pressure and free acid. Without wishing to be bound by theory, it is understood that the majority of the most prevalent impurity ions will precipitate as jarosite [MFe₃(SO₄)₂(OH)₆] and alunite [MAl₃(SO₄)₂(OH)₆], where M is K, Na, etc.

In an embodiment of the invention where the entre leach 19 is directed to the pressure precipitation step 24, the inventors have found that further manganese leaches from the manganese containing material during the pressure precipitation step 24. It has been found that the impurity precipitation releases sulphate ions as available acid that then leaches manganese and minimises sulphates in the precipitate. The further leaching that occurs during the pressure precipitation step 24 can minimise the reagents required in the acid leach step.

An advantage of the pressure precipitation step of the present invention is that acid neutralisation is not required to increase solution pH to a point in which jarosite and alunite precipitate. This reduces reagent costs and also avoids the need for the neutralizing agent, for example Ca, to be removed downstream. The reduction in reagent consumption and residue production also reduces the environmental impact of the process.

In one embodiment, the free acid concentration of the solution entering the pressure precipitation step 24 is at least 10 g/L. In one embodiment, the free acid concentration is between 10 g/L and 40 g/L. Preferably, the free acid concentration is between 10 g/L and 20 g/L.

In one embodiment, the manganese concentration of the solution entering the pressure precipitation step 24 is below 150 g/L. The inventors have found that during the pressure precipitation step 24, manganese will pass through the solubility limit and precipitate before redissolving as the temperature drops at the end of the cycle. The maximum feed concentration is the solubility limit at the post precipitation conditions. Further, as water is evaporated during the cycle so if you are too close to the solubility limit at the feed stage this will result in manganese losses at the end of the cycle. Conversely, treatment of liquors with low manganese content has been found to negatively impact the economics of the pressure precipitation step. In one embodiment, the manganese concentration is between 50 g/L and 150 g/L. Preferably, the manganese concentration is between 90 g/L and 120 g/L.

The pressure precipitation step 24 is carried out in a suitable pressure reactor. Those skilled in the art would recognise suitable equipment to carry out the pressure precipitation step. The equipment should be able to maintain the required temperature and pressure of the pressure precipitation step 24 and exhibit suitable chemical resistance to the leach slurry 19. The pressure precipitation step 24 may be operated as a batch, semi-continuous or continuous process. Those skilled in the art would be able to select suitable pressurised reactors based on the mode of operation.

The pressure precipitation step is conducted at a pressure between 6 and 10 bar. The pressure precipitation step is conducted at a temperature between 150° C. and 180° C.

In one form of the present invention, the residence time of the pressure precipitation step is at least 30 minutes. Preferably, the residence time of the pressure precipitation step is 30-120 minutes.

In one form of the present invention, the discharge from the pressure precipitation reactor is cooled. The cooled slurry then undergoes a solid/liquid separation to remove the precipitated solids 26 from the purified solution 28.

The precipitated solids 26 have a high iron and silica content and may be further processed to prepare an iron-silicate product for use in industry.

FIG. 2 shows an alternative embodiment of the present invention 100 in which the acid leach step and the pressure precipitation step are carried out concurrently. FIGS. 1 and 2 share features and like numerals denote like parts. In this embodiment, the processed stream 16 is directed to a pressure acid leach step 102 where it is contacted with an acidic leach solution 104 and the mixture is maintained at elevated temperature and pressure. In this embodiment, the leaching of the processed stream 16 and the precipitation of impurities from the resulting pregnant leach solution occur in a concurrent step.

The pressure acid leach step 102 is operated at the same conditions as the acid leach step 18 and the pressure precipitation step 24 described above.

The pressure acid leach step 102 is carried out in a suitable pressure reactor. Those skilled in the art would recognise suitable equipment to carry out the pressure acid leach step 102. The equipment should be able to maintain the required temperature and pressure of the pressure acid leach step 102 and exhibit suitable chemical resistance to the leach slurry. The pressure acid leach step 102 may be operated as a batch, semi-continuous or continuous process. Those skilled in the art would be able to select suitable pressurised reactors based on the mode of operation.

In one embodiment, the acidic leach solution 104 is a hydrochloric acid solution or a sulphuric acid solution. Preferably, the acidic leach solution 104 is a sulphuric acid solution. Additionally, or alternatively, a volume of SO₂ gas is pumped into the pressurised reactor at a specified flow rate.

In one embodiment, the pressure acid leach step 102 further comprises the addition of a reducing agent 22. In a preferred embodiment, the reducing agent 22 is a sugar. In one embodiment, the ratio of reducing agent to manganese in pressure acid leach step 102 is substantially the same as that of acid leach step 18.

In one form of the present invention, the acid concentration in pressure acid leach step 102 is substantially the same as that of acid leach step 18.

In one form of the present invention, the pulp density of the manganese containing material in pressure acid leach step 102 is substantially the same as that of acid leach step 18. Preferably, the pulp density is selected to produce a pregnant leach solution with a manganese concentration of less than 150 g/L. More preferably, the pulp density is selected to produce a pregnant leach solution with a manganese concentration between 90 g/L and 120 g/L.

In one embodiment, the pressure acid leach step 102 is conducted at a pressure between 6 and 10 bar. The pressure acid leach step 102 is conducted at a temperature between 150° C. and 180° C.

In one embodiment, the residence time of the pressure acid leach step 102 is at least 30 minutes. Preferably, the residence time of the pressure acid leach step 102 is 30-120 minutes.

The pressure acid leach step 102 results in the formation of a reaction slurry comprising pregnant leach solution, undissolved solids and precipitated impurities. The reaction slurry undergoes a solid/liquid separation to remove the solids 26 from the purified solution 28.

The embodiments shown in FIGS. 1 and 2 both generate a purified solution 28 containing manganese. The purified solution 28 may be treated to removed further impurities.

The recovered purified solution 28 is subjected to a pH correction step 30 where it is contacted with a neutralisation reagent, such as limestone 32 to increase the solution pH to between 3 and 6.5. The increase in solution pH will lead to the precipitation of impurities in the solution without precipitating manganese. The predominant species precipitated is calcium sulfate. The resulting slurry undergoes a solid/liquid separation to remove the precipitated solids 34 from the processed solution 36. The precipitated solid 34 may be further processed to produce a gypsum product.

The processed solution 36 may still contain further impurities and may be subjected to one or more impurity removal steps (not shown) prior to manganese recovery. The one or more impurity removal steps used will depend on the impurities present in the processed solution 36 and the manganese recovery process. Those skilled in the art would appreciate which impurities would impact the recovered manganese product and an appropriate means to remove such impurities.

In one embodiment, the processed solution is subjected to a sulphiding step (not shown) in which the processed solution is contacted with a sulphiding agent. Possible sulphiding agents include Na₂S, BaS, (NH₄)HS, (NH₄)₂S and NaHS. The addition of the sulphiding agent will lead to the precipitation of residual impurity metals as a metal sulphide. Preferably, the pH of the solution during the sulphiding step is at least 5.0-6.2. The resulting slurry undergoes a solid/liquid separation to remove the precipitated solids from the solution.

Additionally or alternatively, the processed solution may be directed to an ion exchange step (not shown) to remove impurities from solution. Alternative or additional impurity removal steps can include a fluoridation step, a precipitation step comprising the addition of a precipitation agent, for example sodium dimethyldithiocarbonate, a solvent extraction step and/or a crystallisation step.

The pressure precipitation step 24, together with any addition impurity removal steps, result in a purified pregnant leach solution 36 that is suitable for manganese recovery.

In the embodiment shown in FIGS. 1 and 2, the purified pregnant leach solution 36 is directed to a solvent extraction circuit 38 to recover manganese. In the solvent extraction circuit 38, the purified pregnant leach solution 36 is contacted with an organic solution of a manganese extractant to selectively extract manganese from the purified pregnant leach solution 36 into a loaded organic phase. Preferably, the contact is conducted in an extraction stage comprising multiple solvent extraction mixer settlers arranged in series. The purified pregnant leach solution 36 and the organic solution of a manganese extractant are contacted in a counter-current arrangement to maximize extraction efficiency. A neutralisation agent 40, such as ammonia or NaOH is dosed to each of the mixer-settlers to maintain a target pH.

In a preferred embodiment, the manganese extractant is a carboxylic acid. Throughout this specification, unless the context requires otherwise, the term “carboxylic acid” will be understood to refer to an organic compound having the general formula R—COOH, with R representing any optionally substituted aliphatic or aromatic group, or combinations of these groups. Such groups include optionally substituted alkyl, alkenyl, alkynyl, aryl, or heteroaryl groups. The term “optionally substituted” should be understood to imply that the group may or may not be further substituted with one or more groups.

Preferably, the carboxylic acid is a trialkylacetic acid. In the current context, the term trialkylacetic acid refers to a carboxylic acid with three alkyl groups on the alpha-carbon. The term “alkyl” should be understood to denote straight chain, branched, mono-cyclic or poly-cyclic alkyls.

Preferably, the carboxylic acid is a C10 carboxylic acid. More preferably, the carboxylic acid is a C10 tertiary carboxylic acid. Still preferably, the carboxylic acid may be represented as:

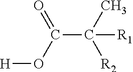

where R1 and R2 are alkyl groups and R1+R2=7 carbons

In one embodiment, the carboxylic acid is neodecanoic acid. Neodecanoic acid is sold under the trade name Versatic 10 (Hexion).

The loaded organic phase is separated from the aqueous raffinate 42. The loaded organic phase is preferably directed to a scrubbing step in which it is contacted with a scrub solution that contains manganese ions. The manganese ions in the scrub solution preferentially load onto the loaded extractant and displaces any impurity elements.

The loaded organic phase is directed to a stripping step in which it is contacted with an acidic strip solution to displace the majority of manganese ions in the organic into the aqueous phase, producing a manganese strip liquor 44.

In the embodiment shown in FIGS. 1 and 2, the manganese strip liquor 44 is directed to crystallisation circuit 46 to recover manganese as manganese sulphate MnSO₄·H₂O 48. In the crystallisation circuit 46, the manganese strip liquor 44 is directed to a suitable evaporator to concentrate the solution and crystallise manganese sulphate.

Whilst the embodiment in FIGS. 1 and 2 detail the recovery of manganese by way of solvent extraction, it is envisaged that other manganese recovery means may be incorporated into the process. In an alternative form of the present invention, the purified pregnant leach solution 36 is directed to a crystallisation step. In an alternative embodiment, the purified pregnant leach solution 36 is directed to an electrowinning circuit to recover, for example, EMM and/or EMD. In an alternative form to the present invention, the purified pregnant leach solution 36 is directed to a neutralisation circuit to prepare chemical manganese dioxide (CMD). In an alternative form of the present invention, the purified pregnant leach solution 36 is directed to a precipitation step in which it is contacted with a suitable precipitating agent to precipitate manganese, for example, as MnO₂ or MnCO₃. Those skilled in the art would recognise that other means of manganese recovery may also be implemented.

### Example 1—Atmospheric SO₂ and Acid Reductive Leaching

A series of tests was undertaken to determine optimum leach extraction conditions using SO₂ reductive leach based on feed material at 80° C. and 30% solids. The parameters and results of the tests are shown in Table 1.

TABLE 1
Leach Extractions

| | | | Final Stoich | | | | | | | |
|---|---|---|---|---|---|---|---|---|---|---|
| | | | SO₂ | Final Residue | | Final Filtrate | | Dissolution | | Mass |
| Test | Feed | Duration | Addition | Conc (%) | | Conc (mg/L) | | from Solids (%) | | Loss |
| Number | Size | (min) | (%) | Mn | Fe | Mn | Fe | Mn | Fe | (%) |
| HY10461 | −3.35 mm | 60 | 116% | 29.7 | 12.9 | 35090 | <1.0 | 23.9 | −6.03 | 13.70 |
| HY10462 | −2.0 mm | 60 | 153% | 30.5 | 12.5 | 40750 | <1.0 | 19.1 | −6.46 | 10.57 |
| HY10463 | −0.5 mm | 60 | 199% | 6.06 | 21.2 | 107000 | 739 | 92.0 | 10.18 | 55.52 |
| HY10543 | −0.5 mm | 240 | 200% | 1.25 | 24.8 | 140700 | 1882 | 98.5 | 4.30 | 59.48 |

The above results indicated very high stoichiometric SO₂ addition, 200% stoichiometry, and extended leach time, 240 minutes, was required to achieve high (>95%) recoveries of Mn.

### Example 2—Atmospheric Sugar and Acid Reductive Leaching

A series of leach tests were undertaken to determine the impact that the addition of sugar has on the leach conditions. These tests were on ore at 20% solids and 180 min leach time except for the feed size tests (HY11279, HY11280, HY11281) which were leached for 240 minutes. The parameters and results of the tests are shown in Table 2 and the final solution tenors are shown in Table 3.

TABLE 2
Leach Extractions

| | | Acid | Sugar | Mass | | | | | | | |
|---|---|---|---|---|---|---|---|---|---|---|---|
| Test | | Stoich | Stoich | Loss | Leached % | | | | | | |
| Number | Feed Type | (%) | (%) | % | Mn | Fe | Al | Ca | K | Mg | Na |
| HY11096 | −0.5 mm Feed | 100 | 150 | 52.2 | 89.9 | 6.4 | 25.2 | 83.5 | 56.3 | 50.6 | 90.1 |
| HY11150 | −0.5 mm Feed | 105 | 150 | 52.2 | 93.0 | 19.8 | 25.3 | 88.3 | 55.9 | 66.3 | |
| HY11146 | −0.5 mm Feed | 110 | 150 | 50.0 | 93.6 | 20.6 | 25.6 | 83.3 | 54.9 | 66.3 | |
| HY11151 | −0.5 mm Feed | 115 | 150 | 57.7 | 97.5 | 38.7 | 24.1 | 89.9 | 60.7 | 65.4 | |
| HY11279 | −0.5 mm Feed | 110 | 150 | 52.0 | 93.4 | 27.7 | 16.8 | 91.6 | 51.0 | 63.7 | 92.8 |
| HY11280 | −2.0 mm Feed | 110 | 150 | 57.1 | 97.1 | 41.0 | 12.8 | 93.6 | 49.1 | 59.2 | 93.8 |
| HY11281 | −3.25 mm Feed | 110 | 150 | 55.6 | 97.2 | 48.0 | 15.2 | 92.6 | 51.2 | 58.0 | 94.7 |
| HY11422 | −0.5 mm Feed | 110 | 110 | 50.9 | 84.6 | 20.3 | 17.5 | 91.5 | 50.1 | 49.2 | 84.7 |
| HY11423 | −0.5 mm Feed | 110 | 125 | 52.2 | 86.7 | 20.2 | 18.2 | 91.8 | 51.4 | 55.6 | 87.4 |
| HY11424 | −0.5 mm Feed | 115 | 110 | 50.9 | 84.4 | 19.9 | 18.0 | 89.9 | 50.7 | 56.2 | 83.3 |
| HY11425 | −0.5 mm Feed | 120 | 110 | 50.9 | 84.1 | 21.2 | 17.6 | 91.5 | 50.7 | 56.2 | 86.0 |

TABLE 3
Solution Tenors

| Test | Feed | Acid | Sugar | Final Leach Solution (mg/L) | | | | |
|---|---|---|---|---|---|---|---|---|
| Number | Type | Stoich (%) | Stoich (%) | Mn | Fe | Al | K | Na |
| HY11096 | −0.5 mm | 100 | 150 | 79430 | 1250 | 1602 | 2440 | 1746 |
| HY11150 | −0.5 mm | 105 | 150 | 84920 | 2619 | 1856 | 2640 | 1700 |
| HY11146 | −0.5 mm | 110 | 150 | 87280 | 2815 | 1954 | 2660 | 1740 |
| HY11151 | −0.5 mm | 115 | 150 | 86830 | 3758 | 1918 | 2950 | 1749 |
| HY11279 | −0.5 mm | 110 | 150 | 81130 | 2967 | 1690 | 3090 | 1414 |
| HY11280 | −2.0 mm | 110 | 150 | 85120 | 3423 | 1710 | 3260 | 1458 |
| HY11281 | −3.25 mm | 110 | 150 | 78140 | 5621 | 1628 | 2950 | 1360 |
| HY11422 | −0.5 mm | 110 | 110 | 79100 | 2546 | 1570 | 2530 | 1438 |
| HY11423 | −0.5 mm | 110 | 125 | 81450 | 2431 | 1572 | 2550 | 1462 |
| HY11424 | −0.5 mm | 115 | 110 | 81840 | 2972 | 1488 | 2640 | 1384 |
| HY11425 | −0.5 mm | 120 | 110 | 80370 | 3212 | 1502 | 2510 | 1406 |

The results show that Mn recovery increases with acid and sugar stoichiometry. High residual acid levels require subsequent neutralization and increase acid requirements.

### Example 3—Effect of Pressure Precipitation Temperature

A series of initial tests were conducted over the 120C to 195C temperature range to determine the optimum pressure precipitation conditions to maximise the precipitation of favourable iron solids. The tests were performed on a leach liquor with the leached solid residue filtered out, and the leach liquor residual free acid adjusted with lime. The leach liquor was directed to a pressure vessel and the temperature of the solution was increased. The increase in temperature also led to an increase in pressure within the vessel. The solution and the precipitated solid were periodically sampled for assay. The results are shown in Tables 4 and 5:

TABLE 4
Solution Tenors

| Temperature | Fe | Al | K | Mg | Na | S | Si |
|---|---|---|---|---|---|---|---|
| (° C.) | mg/L | mg/L | mg/L | mg/L | mg/L | mg/L | mg/L |
| Initial | 5394 | 1672 | 2660 | 758 | 1880 | 66760 | 273 |
| 120 | 1547 | 1188 | 1880 | 802 | 1924 | 65810 | 288 |
| 135 | 533 | 594 | 1350 | 848 | 1964 | 64180 | 257 |
| 150 | 168 | 102 | 670 | 866 | 1510 | 60710 | 255 |
| 165 | 136 | 36 | 640 | 862 | 1484 | 62770 | 271 |
| 180 | 201 | 18 | 990 | 890 | 1426 | 61270 | 303 |
| 195 | 131 | 10 | 1030 | 930 | 1410 | 60820 | 339 |

TABLE 5
Solid Assays

| Temperature | | | | | | | |
|---|---|---|---|---|---|---|---|
| (° C.) | Fe | Al | K | Mg | Na | S | Si |
| 120 | 71.3 | 28.9 | 29.3 | −5.8 | −2.3 | 1.4 | −5.5 |
| 135 | 90.1 | 64.5 | 49.2 | −11.9 | −4.5 | 3.9 | 5.9 |
| 150 | 96.9 | 93.9 | 74.8 | −14.2 | 19.7 | 9.1 | 6.6 |
| 165 | 97.5 | 97.8 | 75.9 | −13.7 | 21.1 | 6.0 | 0.7 |
| 180 | 96.3 | 98.9 | 62.8 | −17.4 | 24.1 | 8.2 | −11.0 |
| 195 | 97.6 | 99.4 | 61.3 | −22.7 | 25.0 | 8.9 | −24.2 |

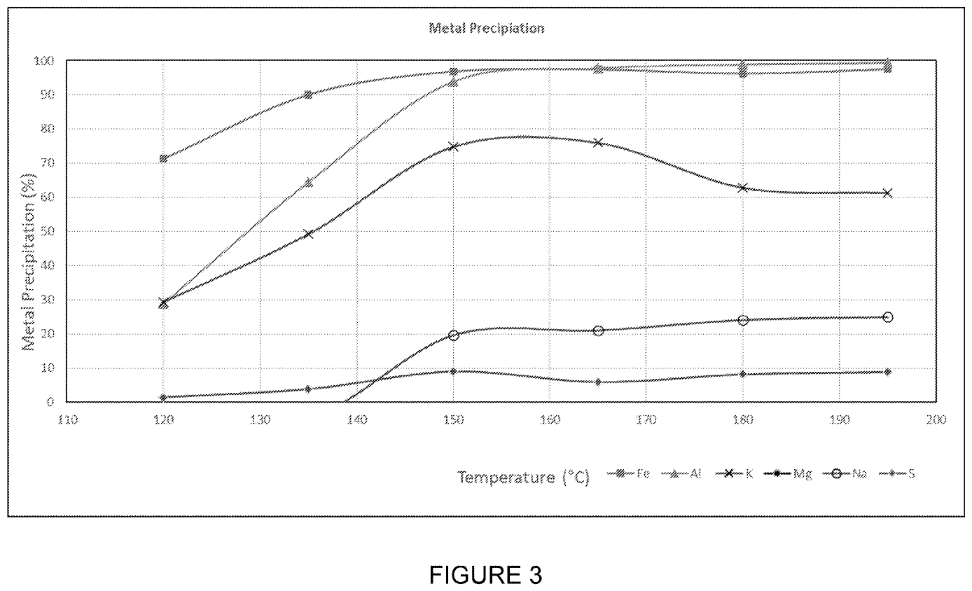

The results are also displayed graphically in FIG. 3. These results indicated that the elevated temperature and pressure of the pressure precipitation step reduced the concentration of Fe in the leach liquor. A large proportion of the Fe precipitated at a temperature of 135° C. with maximum Fe precipitation at 150-190° C.

### Example 4—Atmospheric Sugar and Acid Reductive Leach and Pressure Precipitation Testwork

Test were also carried out on leach slurries containing a mixture of leach liquors and undissolved solids. Initial results indicated that additional Mn recovery was achieved, together with a lower amount of sulphur solids in the final residue. The pregnant leach solution also had lower impurities and final acid levels.

Further test work was conducted to determine the impact that varying stoichiometries had on Mn extraction and impurity removal. These tests were each conducted at 165° C. Table 6 provides the extraction results and Table 7 provides the solution tenors and residue tests.

TABLE 6
Extraction Results

| | | Acid | Sugar | % | | | | | | |
|---|---|---|---|---|---|---|---|---|---|---|
| Test | Feed | Stoich | Stoich | Mass | Extraction % | | | | | |
| Number | Type | (%) | (%) | Loss | Mn | Fe | Al | K | Ca | Mg |
| HY11096 | −0.5 mm | 100 | 150 | 56.0 | 97.9 | 6.6 | 2.6 | 39.6 | 63.7 | 66.8 |
| HY11150 | −0.5 mm | 105 | 150 | 54.2 | 99.3 | 6.6 | 0.5 | 29.5 | 92.7 | 66.8 |
| HY11146 | −0.5 mm | 110 | 150 | 52.2 | 99.4 | 5.9 | −0.9 | 24.5 | 90.8 | 68.1 |
| HY11151 | −0.5 mm | 115 | 150 | 57.7 | 99.5 | 8.2 | −0.2 | 24.8 | 90.9 | 73.7 |
| HY11279 | −0.5 mm | 110 | 150 | 53.8 | 99.4 | 3.2 | −1.7 | 29.4 | 93.7 | 56.0 |
| HY11280 | −2.0 mm | 110 | 150 | 53.8 | 99.4 | 15.7 | −3.2 | 20.0 | 96.9 | 56.7 |
| HY11281 | −3.25 mm | 110 | 150 | 50.0 | 98.9 | 12.1 | 0.2 | 19.5 | 93.7 | 55.8 |
| HY11422 | −0.5 mm | 110 | 110 | 57.7 | 93.9 | 8.0 | 0.2 | 27.9 | 63.5 | 56.8 |
| HY11423 | −0.5 mm | 110 | 125 | 56.0 | 96.0 | 4.9 | 0.3 | 31.2 | 91.5 | 59.3 |
| HY11424 | −0.5 mm | 115 | 110 | 49.4 | 94.3 | 7.5 | 0.2 | 25.5 | 94.8 | 60.2 |
| HY11425 | −0.5 mm | 120 | 110 | 49.1 | 94.5 | 6.6 | −0.9 | 22.4 | 94.7 | 60.0 |
| HY11833 | −0.5 mm | 115 | 115 | 45.4 | 98.9 | 1.8 | 1.7 | 6.4 | 91.5 | 57.3 |
| HY11842 | −0.5 mm | 115 | 115 | 43.5 | 98.3 | 0.1 | 0.6 | 4.4 | 91.2 | 57.6 |
| HY12112 | −0.5 mm | 115 | 115 | 47.4 | 97.6 | 5.5 | −1.1 | 19.0 | 78.6 | 53.9 |
| HY12394 | −0.5 mm | 115 | 115 | 48.5 | 98.5 | 5.4 | −0.8 | 21.2 | 95.6 | 56.5 |
| HY16902 | −0.5 mm | 115 | 115 | 51.2 | 97.8 | 4.8 | −0.4 | 19.3 | 86.8 | 59.7 |

TABLE 7
Solution Tenors

| | Final Precip Soln (mg/L) | | | | | | Final Residue Conc. (%) | | | | | | |
|---|---|---|---|---|---|---|---|---|---|---|---|---|---|
| Test | Fe | Al | K | Na | Ca | Mg | Fe | Al | K | Na | Ca | Mg | S |
| HY11096 | 13 | 16 | 1800 | 1932 | 500 | 422 | 21.6 | 5.38 | 2.26 | 0.082 | 0.200 | 0.190 | 1.98 |
| HY11150 | 148 | 20 | 1670 | 1920 | 525 | 392 | 21.6 | 5.50 | 2.64 | — | 0.040 | 0.190 | 2.41 |
| HY11146 | 355 | 30 | 1530 | 1988 | 580 | 424 | 21.4 | 5.49 | 2.78 | — | 0.050 | 0.180 | 2.79 |
| HY11151 | 444 | 40 | 1410 | 1996 | 485 | 428 | 21.1 | 5.51 | 2.80 | 0.094 | 0.050 | 0.150 | 2.79 |
| HY11279 | 166 | 34 | 1310 | 1496 | 550 | 516 | 20.8 | 5.95 | 2.74 | 0.084 | 0.040 | 0.280 | 2.04 |
| HY11280 | 944 | 18 | 1500 | 1308 | 645 | 502 | 18.4 | 6.13 | 3.15 | 0.082 | 0.020 | 0.280 | 2.83 |
| HY11281 | 154 | 22 | 1260 | 1344 | 695 | 472 | 18.8 | 5.81 | 3.11 | 0.088 | 0.040 | 0.280 | 2.88 |
| HY11422 | 33 | 22 | 1800 | 1730 | 540 | 406 | 19.9 | 5.43 | 2.62 | 0.094 | 0.210 | 0.240 | 2.34 |
| HY11423 | 6 | 12 | 1910 | 1670 | 480 | 466 | 20.9 | 5.51 | 2.54 | 0.086 | 0.050 | 0.230 | 1.93 |
| HY11424 | 128 | 32 | 1640 | 1676 | 500 | 472 | 19.9 | 5.40 | 2.69 | 0.090 | 0.030 | 0.220 | 2.22 |
| HY11425 | 219 | 62 | 1380 | 1620 | 465 | 460 | 20.0 | 5.43 | 2.79 | 0.094 | 0.030 | 0.220 | 2.46 |
| HY11833 | 567 | 78 | 690 | 2188 | 305 | 1014 | 19.4 | 5.29 | 3.34 | 0.106 | 0.050 | 0.250 | 3.75 |
| HY11842 | 303 | 58 | 750 | 2154 | 305 | 1060 | 19.1 | 5.17 | 3.30 | 0.238 | 0.050 | 0.240 | 4.15 |
| HY12112 | 649 | 86 | 1630 | 1688 | 440 | 648 | 19.4 | 5.65 | 3.00 | 0.068 | 0.130 | 0.280 | 2.81 |
| HY12394 | 494 | 82 | 1690 | 1630 | 429 | 584 | 20.0 | 5.71 | 3.01 | 0.078 | 0.030 | 0.270 | 2.72 |
| HY16902 | 719 | 112 | 1280 | 1634 | 455 | 442 | 20.1 | 5.66 | 2.68 | 0.078 | 0.100 | 0.190 | 2.53 |

The results showed that Mn recovery increased with increased sugar stoichiometry (at 110% acid stoichiometry, Mn extraction increased from 93.9% % to 99.4% as the sugar stoichiometry increase from110% to 150%). Ca extraction decreased from 93.7% to 63.5%. Similar overall leach and pressure precipitation Mn extraction,>98.5%, was achieved at 2 and 3 mm particle sizes compared to −0.5 mm.

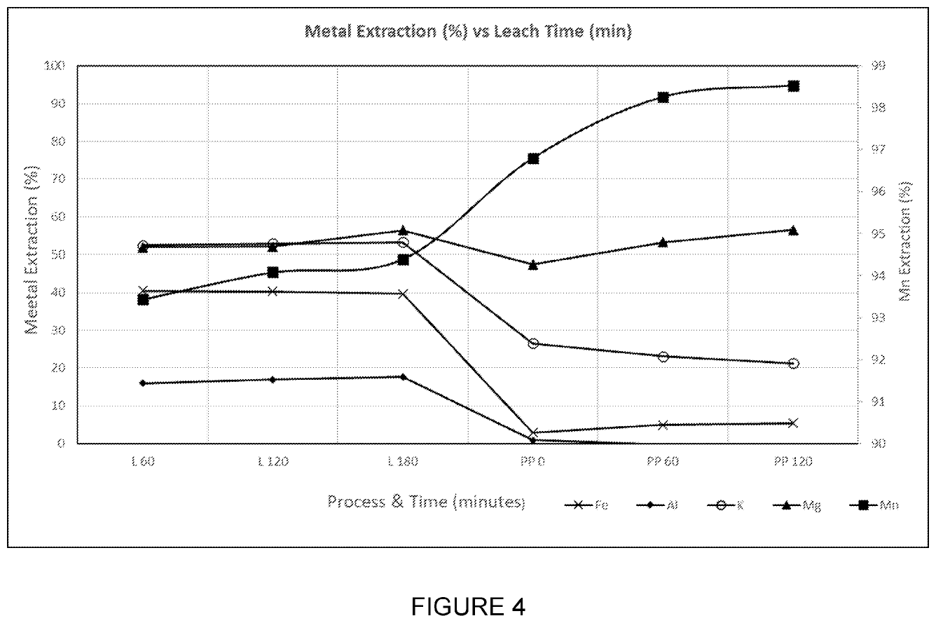

FIG. 4 shows a plot of the typical metal extraction and precipitation kinetics over Leach (L) and Pressure Precipitation (PP) stage is shown in the following graph (Leach Test HY12394, 25% solids, 115% acid and sugar stoichiometry).

This indicates that at 115% stoichiometry Mn extraction increased with time up to 180 minutes in the leach and 120 minutes in the pressure precipitation stages.

### Example 5—Sulphide Precipitation Impurity Removal Testwork

A series of test were undertaken to determine whether remaining impurities in the pregnant leach solution could be removed by sulfide precipitation through the addition of NaHS. Tests were completed at initial solution pH of 3.0, 4.0 & 5.0 and the results are shown in Table 9.

TABLE 8
Sulphide Precipitation Results

| | | | | | | | | | | | | | | Stoich. |
|---|---|---|---|---|---|---|---|---|---|---|---|---|---|---|
| mg/L | Al | Ca | Co | Cu | Fe | K | Mg | Mn | Na | Ni | Pb | Si | Zn | Addition |
| Initial | 52 | 600 | 69 | 28.2 | 237 | | 460 | 87340 | 4748 | 72 | 11 | 325 | 66 | mol:mol |
| Feed¹ | | | | | | | | | | | | | | |
| pH 3.01 | 9 | 714 | BL³ | 3 | 36 | 1746 | 513 | 95175 | 9112 | 7 | 12 | 66 | BL³ | 23 |
| pH 4.13 | 15 | 512 | BL³ | 2 | 34 | 1251 | 375 | 67328 | 7572 | 6 | 9 | 55 | BL³ | 44 |
| pH 5.13 | 12 | 530 | BL³ | 2 | 22 | 1280 | 380 | 67640 | 9204 | BL³ | 10 | 48 | BL³ | 53 |
| % Precipitation² | | | | | | | | | | | | | | |
| pH 3.01 | 83 | −19 | ~100 | 89 | 85 | | −11 | −9 | | 90 | −13 | 80 | ~100 | 23 |
| pH 4.13 | 71 | 15 | ~100 | 92 | 86 | | 18 | 23 | | 92 | 14 | 83 | ~100 | 44 |
| pH 5.13 | 77 | 12 | ~100 | 93 | 91 | | 17 | 23 | | ~100 | 9 | 85 | ~100 | 53 |

¹Feed pH was 1.48 and adjusted prior to use.
²Calculated based on liquor assays.
³Denoted below detection.

As can be seen, the combination of pH adjustment and NaHS addition leaves a solution containing only Ca, Mg, K and Na together with Mn and trace levels of impurities suitable for next stage of purification.

### Example 6—Solvent Extraction Impurity Removal Testwork

The pressure precipitation and sulphide precipitation steps result in an aqueous solution containing Mn, Ca and Mg. Solvent extraction was proposed as a possible means by which to separate Mn from such solutions. Recovery of Mn using solvent extraction was tested using the following conditions:
Aqueous: 90 g/L Mn with Ca & Mg (synthetic) B137784,
Organic: (60% v/v Versatic 10 in Vivasol D80, acid washed)
Tested at an equilibrium pH of 6 and a phase ratio (O/A) of 1.

The results are shown in Table 10.

TABLE 9
Solvent Extraction Testwork

| Successive Contact Number | | | Feed | 1 | 2 | 3 |
|---|---|---|---|---|---|---|
| Sample | | ORG | | EO1 | EO2 | EO3 |
| Coding | | AQ | EF | ER1 | ER2 | ER3 |
| Equilibrium pH at Temp | | | 3.83 | 5.25 | 6.01 | 6.12 |
| Equilibrium Temp | | ° C. | 25 | 34 | 33 | 34 |
| Organic In | | mL | 400 | 400 | 370 | 350 |
| Organic Out | | mL | | 395 | 355 | 345 |
| Density | | g/mL | 0.8668 | 0.8787 | 0.9148 | 0.9200 |
| Aqueous In | | mL | 400 | 400 | 400 | 400 |
| Aqueous Density, g/mL | | g/mL | 1.2204 | 1.2043 | 1.1862 | 1.2129 |
| Aqueous Out | | mL | | 435 | 460 | 420 |
| 200 g/L NaOH | | g | | 29.94 | 70.71 | 14.45 |
| density, g/mL | 1.2135 | | | | | |
| Modifier Volume | | mL | | 24.67 | 58.27 | 11.91 |
| Disengagement² | | sec | | 63 | 84 | 58 |
| Mn | Org Assay | mg/L | 0 | 9956 | 30910 | 38493 |
| | Aq Assay | mg/L | 78010 | 65600 | 50420 | 73020 |
| | % Successive Loading | | | 12.8 | 22.2 | 6.3 |
| | Distribution Coeff. (O/A) | | | 0.2 | 0.6 | 0.5 |
| | (OUT/IN) % | | | 104 | 98 | 105 |
| Mg | Org Assay | mg/L | 0 | 9.6 | 10.2 | 10.0 |
| | Aq Assay | mg/L | 1414 | 1334 | 1192 | 1384 |
| | % Successive Loading | | | 0.68 | 0.04 | −0.01 |
| | Distribution Coeff. (O/A) | | | 0.0 | 0.0 | 0.0 |
| | (OUT/IN) % | | | 103 | 97 | 103 |
| Ca | Org Assay | mg/L | 0 | 48 | 51 | 50 |
| | Aq Assay | mg/L | 480 | 440 | 406 | 480 |
| | % Successive Loading | | | 2.0 | −6.6 | −6.8 |
| | Distribution Coeff. (O/A) | | | 0.0 | 0.0 | 0.0 |
| | (OUT/IN) % | | | 102 | 91 | 98 |

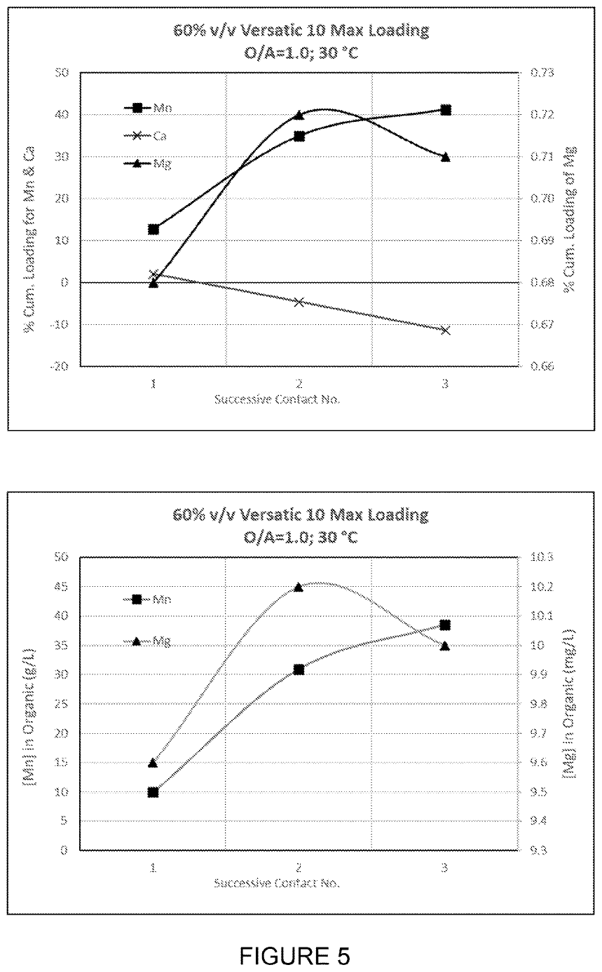

The loading of each species across successive contacts is shown in FIG. 5.

The results show that under optimised conditions, Ca, Mg levels can be decreased by preferentially loading Mn on Versatic 10.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

1. A method for the recovery of manganese from a manganese containing material, the method comprising the steps of:
i. subjecting the manganese containing material to an acid leach step comprising contacting the manganese containing material with an acidic leach solution to produce a leach slurry containing a pregnant leach solution and undissolved solids;
ii. subjecting the pregnant leach solution to a pressure precipitation step, comprising maintaining the pregnant leach solution at elevated temperature and pressure for a time sufficient to precipitate impurities from the pregnant leach solution;
iii. passing the product of step (ii) to a solids/liquid separation step to substantially remove the precipitated impurities and produce a purified pregnant leach solution; and
iv. recovering manganese from the purified pregnant leach solution.

2. The method according to claim 1, wherein the leach slurry is treated in the pressure precipitation step.

3. The method according to claim 1, wherein the pressure precipitation step is carried out in a pressurised reactor.

4. The method according to claim 1, wherein the acid leach step and the pressure precipitation step are conducted independently.

5. The method according to claim 1, wherein the acid leach step and the pressure precipitation step are conducted concurrently.

6. The method according to claim 5, wherein the manganese containing material is contacted with an acidic leach solution at elevated temperature and pressure to produce a leach slurry containing a pregnant leach solution and undissolved solids and the elevated temperature and pressure are maintained for a time sufficient to precipitate impurities from the pregnant leach solution.

7. The method according to claim 6, wherein the manganese containing material is contacted with an acidic leach solution in a pressurised reactor maintained at elevated temperature and pressure.

8. The method according to claim 1, wherein the acid leach step comprises contacting the manganese containing material with an acidic leach solution in the presence of a reducing agent.

9. The method according to claim 8, wherein the reducing agent is a sugar.

10. The method according to claim 1, wherein the pressure precipitation step is conducted at a pressure of at least 2 bar (absolute).

11. The method according to claim 10, wherein the pressure precipitation step is conducted at a pressure between 2 and 10 bar (absolute).

12. The method according to claim 1, wherein the pressure precipitation step is conducted at a temperature of at least 135° C.

13. The method according to claim 12, wherein the pressure precipitation step is conducted at a temperature of at least 150° C.

14. The method according to claim 1, wherein the residence time of the pressure precipitation step is at least 30 minutes.

15. The method according to claim 1, wherein the purified pregnant leach solution is subjected to a pH conditioning step.

16. The method according to claim 1, wherein recovering manganese from the purified pregnant leach solution comprises subjecting at least a portion of the purified pregnant leach solution to a crystallisation step to produce a manganese salt.

17. The method according to claim 1, wherein recovering manganese from the purified pregnant leach solution comprises subjecting at least a portion of the purified pregnant leach solution to an electrowinning step to produce manganese metal.

18. The method according to claim 1, wherein the recovering manganese from the purified pregnant leach solution comprises subjecting the purified leach solution to a solvent extraction step comprising contacting the purified leach solution with an organic solution of an extractant suitable to extract manganese ions into the organic solution and separating a loaded organic solution from an aqueous raffinate.

19. The method according to claim 18, wherein the solvent extraction step further comprises the recovery of manganese from the loaded organic solution.
